(19) United States
(12) Patent Application Publication
(10) Pub. No.: US 2004/0045173 A1
(43) Pub. Date: Mar. 11, 2004

(54) Cutting device comprising two jaws which can be moved one over the other by means of manual operation

(76) Inventor: Winfried Ebert, Weibern (DE)

Correspondence Address: BELL, BOYD & LLOYD, LLC, PO BOX 1135, CHICAGO, IL, 60690-1135, US

(21) Appl. No.: 10/416,951

(22) PCT Filed: Nov. 9, 2001
(86) PCT No.: PCT/EP01/12980

(30) Foreign Application Priority Data
Nov. 15, 2000 (DE) 10056743.6

(51) Int. Cl. B26B 17/00

(52) U.S. Cl. 30/188; 30/186; 30/179

(57) ABSTRACT

A cutting device has two jaws (1, 2) which can be moved one over the other by means of manual operation. At least one of the jaws has a cutter (3) and a protective nose (4). The protective nose (4) is arranged in front of the cutter (3) and projects into the cutting mouth extending between the jaws (1,2). The protective nose (4) can evade a restoring force (7). One of the jaws (1) embodies an avoidance chamber (5). A bottom (6) of the avoidance chamber (5) supports the end of a spring (7). An end of the spring (7) engages the protective nose (4).

### CROSS REFERENCE TO RELATED APPLICATION

This application claims priority of German Patent Application Number 10056743.6, filed Nov. 15, 2000, and International Application Number PCT/EP01/12980, filed Nov. 9, 2001, the entire disclosures of which are incorporated herein by reference.

### BACKGROUND OF THE INVENTION

The present invention relates to cutting devices. The present invention also relates to a cutting device having two jaws which can be moved toward one another by handle actuation. The present invention further relates to a cutting device in which at least one jaw forms a cutting edge and one jaw provides a protective nose which is disposed in front of the cutting edge and projects into the cutting mouth extending between the jaws.

A cutting device is known from EP 06 A 98450.

An object of the present invention is to provide a new cutting device in a functionally advantageous manner.

### SUMMARY OF THE INVENTION

In an embodiment, the present invention provides a cutting device having a protective nose that can yield counter to a restoring force. If the protective nose is not acted upon, then it projects out of the jaw in order to increase the operational safety of the device. The protective nose can move into the jaw when it is acted upon in the direction transverse to the direction in which the jaw or the cutting edge extends. The protective nose thus moves out of the cutting mouth.

A yielding action of the protective nose moving out of the cutting mouth can take place, in particular, when the cutting edge is used for cutting. The protective nose is acted upon by the material which is to be cut, and yields in a guided manner transversely to the extent of the cutting edge.

In a preferred configuration of the cutting device invention, the jaw has an escape chamber, on the base of which is supported one end of a spring. The other end of the spring acts on the protective nose. The protective nose is retained in the escape chamber by means of a latching hook. The wall of the escape chamber forms a linear guide for the protective nose. The protective nose is preferably located directly in front of an exchangeable blade.

The jaw which is located opposite the jaw which carries the cutting edge may be formed as an anvil. In the closed position, in which the cutting edge is located on the anvil, the protective nose may project to just in front of the anvil.

The jaws are preferably associated with ends of levers. The other ends of the levers form grips and which cross over at a point of articulation. It is possible for these levers to be retained in a spring-biassed closed position by means of blocking slides.

A gap may remain between the anvil and end of the protective nose when the cutting edge rests on the anvil. In another embodiment, however, in the closed position of the cutting device, the protective nose rests on the anvil and is deflected inward to a slight extent.

Additional features and advantages of the present invention are described in, and will be apparent from, the following Detailed Description of the Invention and the figures.

### BRIEF DESCRIPTION OF THE FIGURES

A detailed example of the invention is explained hereinbelow with reference to accompanying drawings.

FIG. 1 shows a sectional illustration of the exemplary embodiment.

FIG. 2 shows an enlarged illustration of the end portion of the jaw which carries the protective nose.

FIG. 3 shows, in elevation, an illustration according to FIG. 1.

FIG. 4 shows a section along line IV-IV in FIG. 3.

### DETAILED DESCRIPTION OF THE INVENTION

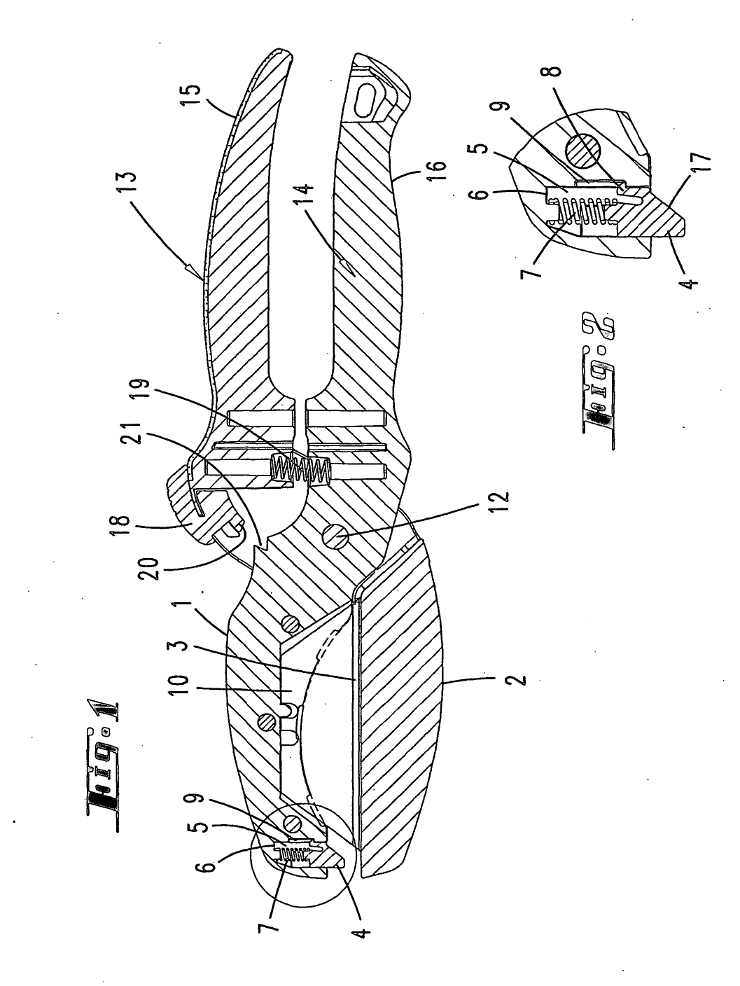

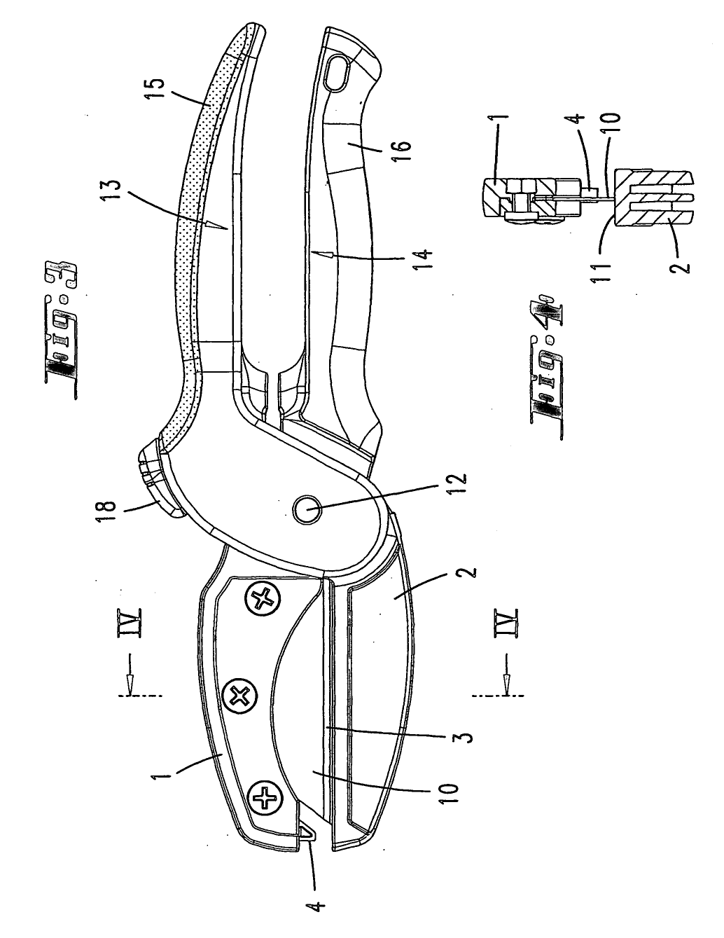

Referring to FIGS. 1 and 3, a cutting device has two levers 13, 14, which each form plastics-material grips 15 and 16 which can be clasped by the user's hand. The two levers 13, 14 are connected to one another such that they cross over at a point of articulation 12. Those portions of the levers 13, 14 which are located opposite the grips 15, 16 form jaws 1, 2. The jaw 1 is configured as a cutting edge 3. The jaw 2 is configured as an anvil 11.

The cutting edge 3 is formed by an exchangeable blade 10 which, in the closed position (FIGS. 1 and 3), is located on the anvil 2.

Referring also to FIGS. 2 and 4, a protective nose 4 is located at the free end of the jaw 1, which carries the blade 10. The protective nose 4 can be displaced transversely to the direction in which the cutting edge 3 extends. For this purpose, the protective nose 4 is formed as a slide which can move right into an escape chamber 5 of the jaw 1. Located in the escape chamber 5 is a compression spring 7 which, by way of one end, is supported on the base 6 of the escape chamber 5 and, by way of its other end, presses against the slide which forms the protective nose 4, so that the slide entering into the escape chamber 5 is forced back again by the spring 7. The spring 7 holds the protective nose 4 in a stop position. For this purpose, the protective nose 4 provides a latching hook 8 which can be displaced in a latching groove 9 of the escape chamber 5. The end of the latching groove 9 defines a latching shoulder for the latching hook 8. For fitting purposes, the latching hook 8 is disposed at the end of an elastic spring.

The portion of the protective nose 4, which passes out of the jaw 1, provides a slope 17 on its side which is oriented toward the blade 10. The protective nose 4 can move right into the jaw 1 until its end side is aligned with the periphery of the escape chamber 5, so that it is possible to realize a pushed-in position in which no problems are posed by any projections. The moving-in action takes place in association with the grips 15, 16 being moved toward one another.

The two levers 13, 14 are spring-biassed against one another by means of a compression spring 19. The compression spring 19 is subjected to stressing when the lever arms 13, 14 or the jaws 1, 2 are moved toward one another.

In the closed position, which is illustrated in FIGS. 1 and 3, it is possible for the levers 13, 14 to be blocked against pivoting. For this purpose, a blocking slide 18 is provided. The blocking slide 18 has a latching protrusion 20 which, by virtue of the blocking slide 18 being displaced into a blocking position, engages in a latching niche 21 of the other lever 14.

All features disclosed are (in themselves) pertinent to the invention. The disclosure contents of the associated/attached priority documents (copy of the prior application) are hereby also included in full in the disclosure of the application, also for the purpose of incorporating features of these documents in claims of the present application.It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. Cutting device having two jaws (1, 2) which can be moved toward one another by handle actuation and of which at least one forms a cutting edge (3) and one provides a protective nose (4) which is disposed in front of the cutting edge (3) and projects into the cutting mouth extending between the jaws (1, 2), characterized in that the protective nose (4) can be moved away counter to a restoring force (7).

2. Cutting device according to claim 1 or in particular according thereto, characterized by an escape chamber (5) which is associated with the jaw (1) and on the base (6) of which is supported one end of a spring (7) which, by way of its other end, acts on the protective nose (4).

3. Cutting device according to one or more of the preceding claims or in particular according thereto, characterized in that the protective nose (4) is retained in the escape chamber (5) by means of a latched hook (8).

4. Cutting device according to one or more of the preceding claims or in particular according thereto, characterized in that the cutting edge (3) is formed by an exchangeable blade (10).

5. Cutting device according to one or more claims or in particular according thereto, characterized in that the jaw carrying the cutting edge (3) has located opposite it a jaw (2) depicted as an anvil (11).

6. Cutting device according to one or more claims or in particular according thereto, characterized in that the jaws (1, 2) are associated with the one arms of levers (13, 14) which cross over at a point of articulation (12) and the other arms of which form grips (15, 16).

7. Cutting device according to one or more claims or in particular according thereto, characterized in that the levers (13, 14) which are spring-biassed against one another can be blocked against pivoting in a position in which the cutting edge (3) is located on the anvil.

8. Cutting device according to one or more claims or in particular according thereto, characterized in that, in the closed position of the cutting device, the protective nose has its end resting on the anvil (11).
